(19) United States
(12) Patent Application Publication
(10) Pub. No.: US 2014/0079971 A1
(43) Pub. Date: Mar. 20, 2014

(54) LITHIUM BATTERY STRUCTURE

(71) Applicant: DIJIYA ENERGY SAVING TECHNOLOGY INC., New Taipei City (TW)

(72) Inventor: Wen-Hung HUANG, New Taipei City (TW)

(73) Assignee: DIJIYA ENERGY SAVING TECHNOLOGY INC., New Taipei City (TW)

(21) Appl. No.: 13/782,628

(22) Filed: Mar. 1, 2013

(30) Foreign Application Priority Data
Sep. 19, 2012 (TW) 101134321

(51) Int. Cl. H01M 10/28

(52) U.S. Cl. CPC H01M 10/286
USPC 429/94

(57) ABSTRACT

A lithium battery structure mainly comprises a case having a cover plate connected with a first terminal component and a second terminal component. The first terminal component is electrically connected to a top end of the anode plate, a bottom end of the anode plate is extended and bent downwardly to form an anode coupling portion, and the anode coupling portion is connected to at least an anode tab at a top end of the winding core. The second terminal component is electrically connected to a top end of the cathode plate, a bottom end of the cathode plate is extended and bent downwardly to form a cathode coupling portion, and the cathode coupling portion is connected to at least a cathode tab at the top end of the winding core.

### BACKGROUND OF THE INVENTION

1. Field of Invention

The present invention relates to a lithium battery structure and more particularly to a lithium battery structure for effectively saving assembling costs and ensuring safety in usage.

2. Related Art

A conventional lithium metal battery mainly comprises a case, an electrolyte solution disposed inside the case and a lithium battery winding core. The lithium battery winding core is composed of an anode plate, an insulation diaphragm and a cathode plate assembled by winding. The anode plate and the cathode plate are respectively welded with an anode tab and a cathode tab. Then, the anode tab is welded on an inner wall of the case. The case is electrically connected to an anode terminal post. The cathode tab is welded on a bottom of a cathode terminal post of the case. The anode terminal post and the cathode terminal post are respectively screwed into a nut through an external screw thread disposed on a top of the anode terminal post and the cathode terminal post for fixing different wiring terminals and outputting a positive and a negative power respectively.

Because the anode tab is welded on the inner wall of the case, the case is electrically charged. Therefore, the metal case has to be covered by a thermoplastic film. However, in the practical application, the thermoplastic film is not heat-resistant, can be hardened and is frangible. As a result, the thermoplastic film can easily burst to expose the case and causes a short circuit.

Furthermore, because it is difficult to control the quality of welding the anode tab of the winding core on the inner wall of the case, and the cathode tab of the winding core on the bottom of the cathode terminal post of the case; and the welding is usually limited to point-to-point contact, poor electrical conduction and heat dissipation can be caused easily.

In view of the above problems and in order to improve the drawbacks, the present invention provides a lithium battery structure that is more stable, can prevent from short circuit so as to ensure safety in using, and can effectively enhance the electrical conduction and heat dissipation effect.

### SUMMARY OF THE INVENTION

An object of the present invention is to provide a lithium battery structure with an extended anode plate and an extended cathode plate disposed below a cover plate. The anode plate is welded to at least an anode tab, the cathode plate is welded to at least a cathode tab. Thereby, the operational efficiency can be enhanced and manpower can be saved.

Another object of the present invention is to provide a lithium battery structure by which the anode plate and the cathode plate can be respectively electrically connected to a first terminal component, a second terminal component as well as the anode tab and the cathode tab of a winding core with large areas of contact for effective electrical conduction and heat dissipation.

Still another object of the present invention is to provide a lithium battery structure with an anode tab set and a cathode tab set respectively and directly formed on a top end of the anode plate and the cathode plate for meeting the requirements of large volume and high power battery assembling.

In order to achieve the above-mentioned objects, the present invention provides a lithium battery structure that comprises a case, a first terminal component, a second terminal component, an anode plate, a cathode plate and a winding core. The case comprises a lower case with an opening disposed at a top end of the lower case, and a cover plate for covering the top end of the lower case and for sealing the opening. The first terminal component and the second terminal component are connected on the cover plate of the case. The anode plate is coupled below the cover plate; a top end of the anode plate is electrically connected to the first terminal component; and a bottom end of the anode plate is extended and bent downwardly to form an anode coupling portion. The cathode plate is coupled below the cover plate; a top end of the cathode plate is electrically connected to the second terminal component; and a bottom end of the cathode plate is extended and bent downwardly to form a cathode coupling portion. The winding core is accommodated inside the lower case. At least an anode tab and at least a cathode tab are disposed at a top end of the winding core. The anode tab is electrically connected to the anode coupling portion, and the cathode tab is electrically connected to the cathode coupling portion.

In implementation, the winding core is formed by laminating a rectangular anode plate, a first separator, a rectangular cathode plate and a second separator, and then continuously winding the laminated ones. A top end of the anode plate is connected to the anode tab, and a top end of the cathode plate is connected to the cathode tab.

In implementation, a large proportion of a surface area of the anode plate is formed as an anode area, and a plurality of spaced anode tabs is disposed on one of the long sides of the anode plate. A large proportion of a surface area of the cathode plate is formed as a cathode area. The cathode area and the anode area are arranged to be corresponding to each other. A plurality of spaced cathode tabs is disposed on one of the long sides of the cathode plate. When the rectangular anode plate and the rectangular cathode plate are superimposed, the cathode tabs and the anode tabs are disposed alternatively. The anode tabs are put together as an anode tab set and the cathode tabs are put together as a cathode tab set.

In implementation, an upper insulation plate is disposed at a top side inside the lower case. A top side of the winding core and the cover plate are separated by the upper insulation plate. A lower insulation plate is disposed at a bottom side inside the lower case. A bottom side of the winding core and the lower case are separated by the lower insulation plate.

In implementation, two through holes are disposed on a plate surface of the upper insulation plate for the anode tab and the cathode tab at the top end of the winding core to pass through respectively.

In implementation, a free end of the anode coupling portion of the anode plate is extended horizontally toward the cathode plate, and a free end of the cathode coupling portion of the cathode plate is extended horizontally toward the anode plate.

The present invention will become more fully understood by reference to the following detailed description thereof when read in conjunction with the attached drawings.

### BRIEF DESCRIPTION OF THE DRAWINGS

FIG. 1 is an exploded perspective view of a lithium battery structure according to a preferred embodiment of the present invention;

FIG. 2 is a perspective view of the lithium battery structure according to the preferred embodiment of the present invention;

FIG. 3 is a sectional assembling view of the lithium battery structure according to the preferred embodiment of the present invention;

FIG. 4 is an exploded perspective view of a winding core according to the preferred embodiment of the present invention;

FIG. 5 is a perspective view of the superimposed winding core according to the preferred embodiment of the present invention;

FIG. 6 is a perspective view of the winding core being winded according to the preferred embodiment of the present invention; and

FIG. 7 is a perspective view of the winded winding core according to the preferred embodiment of the present invention.

### DETAILED DESCRIPTION OF THE INVENTION

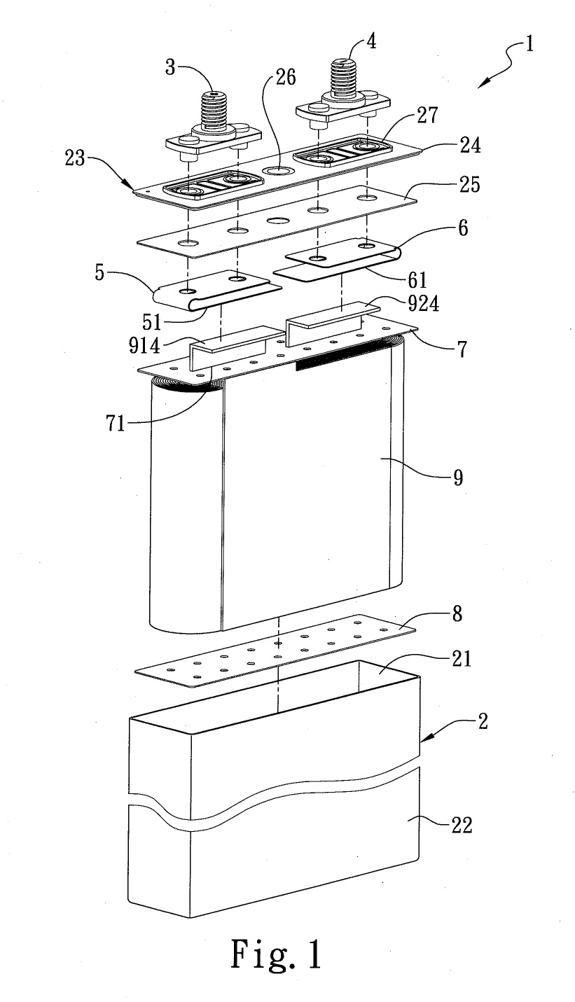

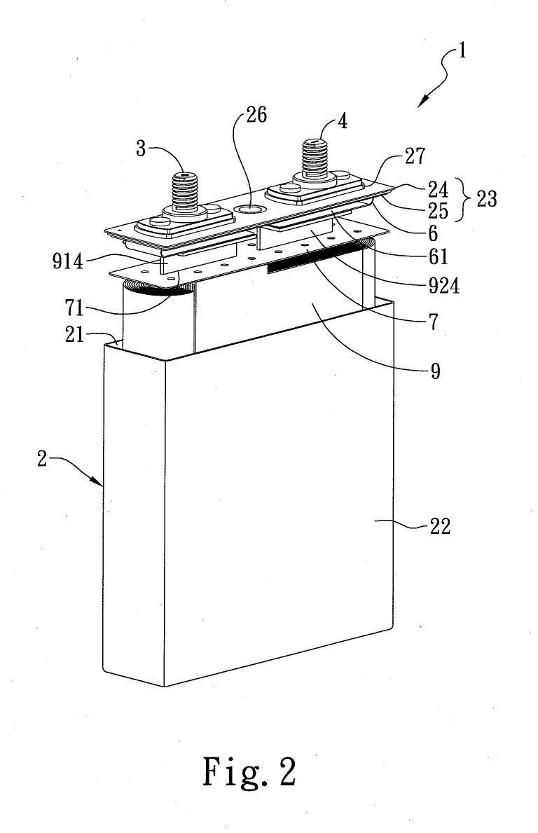

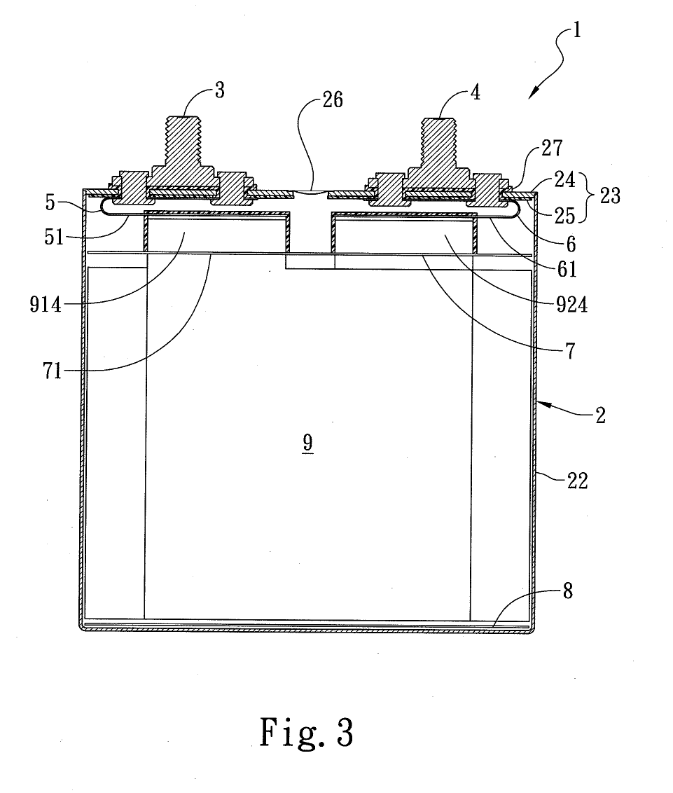

Please refer to FIGS. 1 to 3. FIGS. 1 to 3 showing a lithium battery structure 1 according to a preferred embodiment of the present invention. The lithium battery structure 1 provided by the present invention comprises a case 2, a first terminal component 3, a second terminal component 4, an anode plate 5, a cathode plate 6, an upper insulation plate 7, a lower insulation plate 8 and a winding core 9.

The case 2 is hollow and is in a rectangular shape. The case 2 comprises a lower case 22 with an opening 21 disposed at a top end of the lower case 22, and a cover plate 23 for covering the top end of the lower case 22 and for sealing the opening 21. The cover plate 23 comprises a top plate 24 and an insulation plate 25. The top plate 24 is superimposed on the insulation plate 25. An explosion-proof hole 26 is formed on a central part of the cover plate 23. A plastic sleeve 27 is respectively disposed on the cover plate 23 by two sides of the explosion-proof hole 26. A hollow tube on a bottom side of any one of the plastic sleeves 27 is protruded downwardly for penetrating through the top plate 24 and the insulation plate 25 respectively.

The first terminal component 3 and the second terminal component 4 are placed on the two plastic sleeves 27 respectively. A top end of the anode plate 5, the cover plate 23 and the first terminal component 3 are connected and fixed with each other by riveting. A top end of the cathode plate 6, the cover plate 23 and the second terminal component 4 are connected and fixed with each other by riveting. Thereby, the insulation plate 25 is located between the top plate 24 and the anode and cathode plates 5 and 6. After the top end of the anode plate 5 and the top end of the cathode plate 6 are fixed, the anode plate 5 is bent downwardly to form an anode coupling portion 51, and a free end of the anode coupling portion 51 is extended horizontally toward the cathode plate 6. The cathode plate 6 is bent downwardly to form a cathode coupling portion 61, and a free end of the cathode coupling portion 61 is extended horizontally toward the anode plate 5.

The upper insulation plate 7, the lower insulation plate 8 and the winding core 9 are accommodated inside the lower case 22. Two through holes 71 are disposed on the upper insulation plate 7. The upper insulation plate 7 and the lower insulation plate 8 are in rectangular shape and are disposed on top of the winding core 9 and under the winding core 9 respectively.

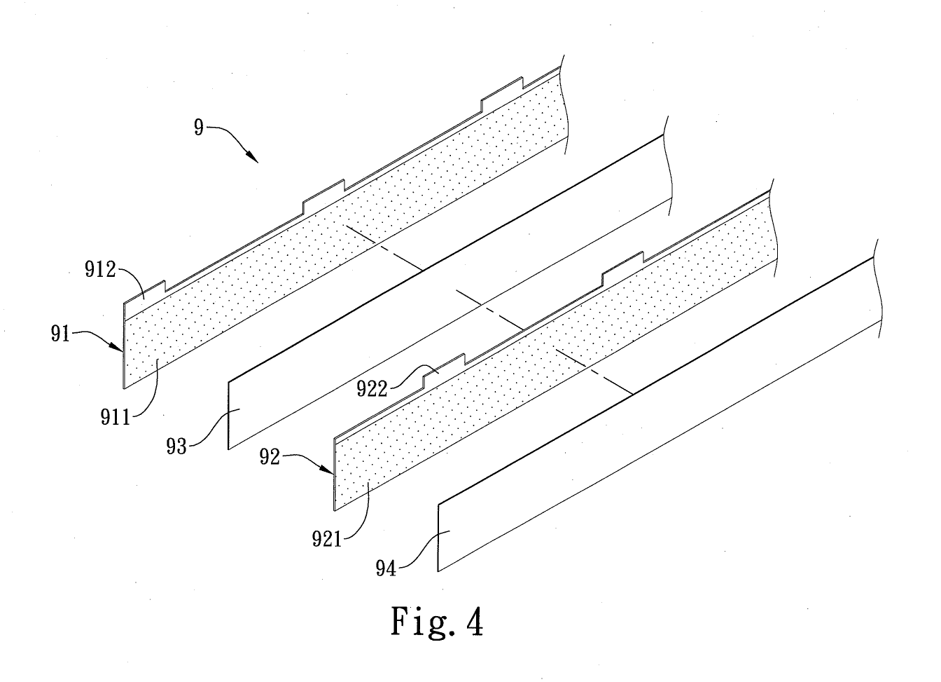

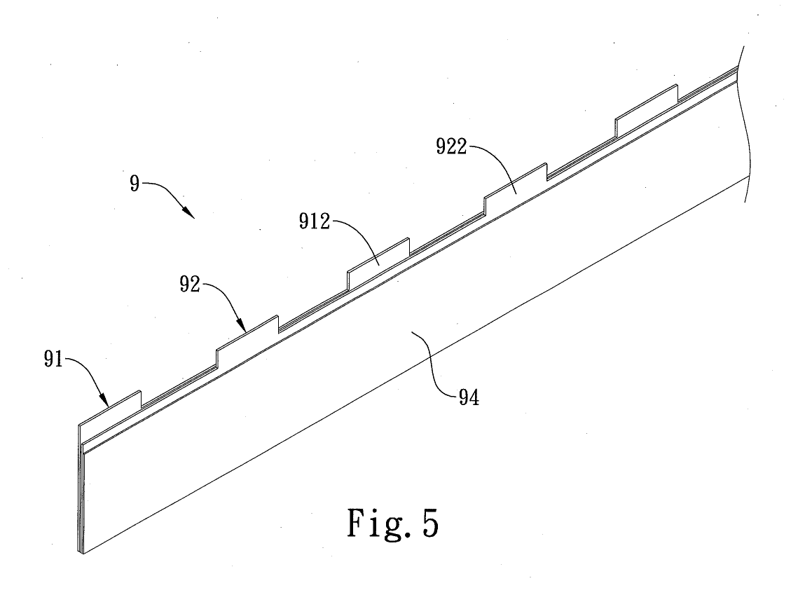

As shown in FIGS. 4 and 5, the winding core 9 comprises a rectangular anode plate 91, a rectangular cathode plate 92, a first separator 93 and a second separator 94. The anode plate 91 is preferably made of aluminum. A large proportion of a lower area of a front surface and a back surface of the anode plate 91 are formed as an anode area 911. The anode area 911 is a layer of anode paste mixed with anode material, conductivity promoter, adhesive and dissolvent coated on the surface of the anode plate 91; and is formed by dry-baking and rolling the anode paste. A plurality of evenly spaced anode tabs 912 is disposed on one of the long sides of the anode plate 91, which is also an upper area of the anode plate 91.

The cathode plate 92 is preferably made of copper. A large proportion of a lower area of a front surface and a back surface of the cathode plate 92 are formed as a cathode area 921. The cathode area 921 corresponds to the anode area 911 of the anode plate 91. The cathode area 921 is a layer of cathode paste mixed with cathode material, conductivity promoter, adhesive and dissolvent coated on the surface of the cathode plate 92; and is formed by dry-baking and rolling the cathode paste. A plurality of evenly spaced cathode tabs 922 is disposed on one of the long sides of the cathode plate 92. When the anode plate 91 and the cathode plate 92 are superimposed together, the disposing positions of the cathode tabs 922 and the anode tabs 912 are arranged alternatively.

The first separator 93 and a second separator 94 are made of an insulation material, for example, polythene (PE), polypropylene (PP), or a multiple layered structure composed of PE and PP, for example, PE/PP/PE. The first separator 93 is located between the anode area 911 of the anode plate 91 and the cathode area 921 of the cathode plate 92. The second separator 94 is disposed on a side of the cathode area 921 of the cathode plate 92.

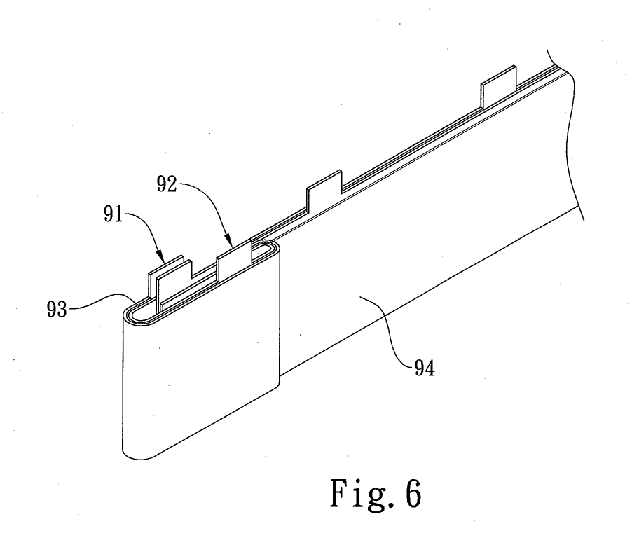

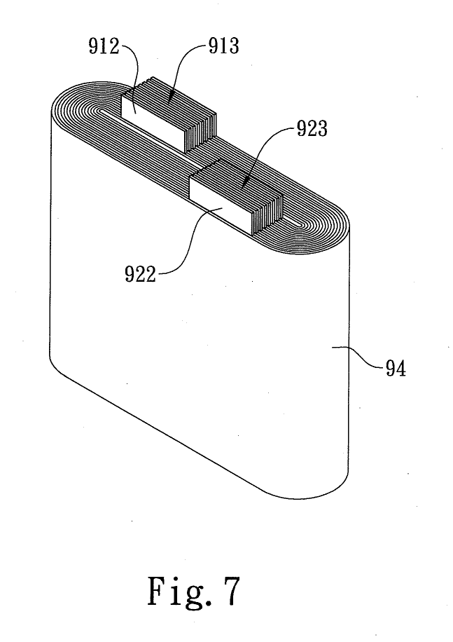

As shown in FIG. 6, the anode plate 91, the first separator 93, the cathode plate 92 and the second separator 94 are winded together continuously in order that the anode area 911 of the anode plate 91 and the cathode area 921 of the cathode plate 92 are separated between the first separator 93 and the second separator 94. As shown in FIG. 7, the anode tabs 912 are put together as an anode tab set 913 and the cathode tabs 922 are put together as a cathode tab set 923.

Please refer to Figs, 1 and 2 again, after the anode tab set 913 is welded on an anode connection plate 914 and the cathode tab set 923 is welded on a cathode connection plate 924, the anode connection plate 914 and the cathode connection plate 924 penetrate upwardly through the two through holes 71 of the upper insulation plate 7 respectively, and are welded to bottom ends of the first terminal component 3 and the second terminal component 4. Thereby, the anode tab set 913 and the first terminal component 3 are electrically connected, and the cathode tab set 923 and the second terminal component 4 are electrically connected.

Thereby, when the upper insulation plate 7, the lower insulation plate 8 and the winding core 9 are accommodated inside the lower case 22 and an electrolyte solution is filled inside, a top side of the winding core 9 and the cover plate 23 are separated by the upper insulation plate 7, and a bottom side of the winding core 9 and the lower case 22 are separated by the lower insulation plate 8. Therefore, a positive power and a negative power can be outputted by the first terminal component 3 and the second terminal component 4 respectively through the effect of the winding core 9, and the case 2 and the winding core 9 are insulated from each other for preventing short circuit from occurring caused by electric leakage.

Therefore, the present invention has the following advantages:

1. The present invention can insulate the case and the winding core from each other. Therefore, when a positive power and a negative power are outputted by the first terminal component and the second terminal component respectively through the effect of the winding core, short circuit can be effectively prevented from occurring caused by electric leakage in order to ensure safety in using.

2. By employing the present invention, the anode tab and the cathode tab can be respectively electrically connected to the anode plate and the cathode plate with large areas of contact. Therefore, the conducted voltage and current can be stabilized, large currents can be loaded, and heat can be dissipated effectively for increasing the life expectancy of the product.

3. In the present invention, because the extended anode plate and the extended cathode plate are disposed below the cover plate, at least one of the anode tabs is welded on the anode plate and at least one of the cathode tabs is welded on the cathode plate, and the anode tabs and the cathode tabs are directly formed from the anode plate and the cathode plate; the operational efficiency can be enhanced effectively and manpower can be saved.

4. In the present invention, the anode tab set and the cathode tab set are respectively and directly formed on the top ends of the anode plate and the cathode plate for meeting the requirements of large volume and high power battery assembling.

As a conclusion from the above disclosed descriptions, the present invention can achieve the expected objects to provide the lithium battery structure that can make the structure of a lithium battery more stable, prevent from the short circuit so as to ensure safety in using, and effectively enhance the electrical conduction and heat dissipation effect.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A lithium battery structure, comprising:
a case comprising a lower case with an opening disposed at a top end of the lower case, and a cover plate for covering the top end of the lower case and sealing the opening;
a first terminal component and a second terminal component connected on the cover plate of the case respectively;
an anode plate coupled below the cover plate, a top end of the anode plate being electrically connected to the first terminal component, a bottom end of the anode plate being extended and bent downwardly to form an anode coupling portion;
a cathode plate coupled below the cover plate, a top end of the cathode plate being electrically connected to the second terminal component, a bottom end of the cathode plate being extended and bent downwardly to form a cathode coupling portion; and
a winding core accommodated inside the lower case, at least an anode tab and at least a cathode tab being disposed at a top end of the winding core, the anode tab being electrically connected to the anode coupling portion, the cathode tab being electrically connected to the cathode coupling portion.

2. The lithium battery structure as claimed in claim 1, wherein the cover plate comprises a top plate and an insulation plate, the top plate is superimposed on the insulation plate, and the insulation plate is located between the top plate and the anode and cathode plates.

3. The lithium battery structure as claimed in claim 1, wherein the winding core is formed by laminating a rectangular anode plate, a first separator, a rectangular cathode plate and a second separator and then continuously winding the laminated ones, a top end of the anode plate is connected to the anode tab, and a top end of the cathode plate is connected to the cathode tab.

4. The lithium battery structure as claimed in claim 3, wherein a large proportion of a surface area of the anode plate is formed as an anode area, a plurality of spaced anode tabs is disposed on one of the long sides of the anode plate, a large proportion of a surface area of the cathode plate is formed as a cathode area, the cathode area and the anode area are arranged to be corresponding to each other, a plurality of spaced cathode tabs is disposed on one of the long sides of the cathode plate, and when the rectangular anode plate and the rectangular cathode plate are superimposed, the cathode tabs and the anode tabs are disposed alternatively, after the anode plate, the first separator, the cathode plate and the second separator are continuously winded, the anode tabs are put together as an anode tab set and the cathode tabs are put together as a cathode tab set.

5. The lithium battery structure as claimed in claim 4, wherein an upper insulation plate is disposed at a top side inside the lower case, a top side of the winding core and the cover plate are separated by the upper insulation plate, a lower insulation plate is disposed at a bottom side inside the lower case, a bottom side of the winding core and the lower case are separated by the lower insulation plate.

6. The lithium battery structure as claimed in claim 5, wherein two through holes are disposed on a plate surface of the upper insulation plate for the anode tab and the cathode tab at the top end of the winding core to pass through respectively.

7. The lithium battery structure as claimed in claim 4, wherein a free end of the anode coupling portion of the anode plate is extended horizontally toward the cathode plate, a free end of the cathode coupling portion of the cathode plate is extended horizontally toward the anode plate.

8. The lithium battery structure as claimed in claim 3, wherein an upper insulation plate is disposed at a top side inside the lower case, a top side of the winding core and the cover plate are separated by the upper insulation plate, a lower insulation plate is disposed at a bottom side inside the lower case, a bottom side of the winding core and the lower case are separated by the lower insulation plate.

9. The lithium battery structure as claimed in claim 8, wherein two through holes are disposed on a plate surface of the upper insulation plate for the anode tab and the cathode tab at the top end of the winding core to pass through respectively.

10. The lithium battery structure as claimed in claim 3, wherein a free end of the anode coupling portion of the anode plate is extended horizontally toward the cathode plate, a free end of the cathode coupling portion of the cathode plate is extended horizontally toward the anode plate.
